(19) United States
(12) Patent Application Publication
(10) Pub. No.: US 2004/0096102 A1
(43) Pub. Date: May 20, 2004

(54) Methodology for scanned color document segmentation

(75) Inventor: John C. Handley, Fairport, NY (US)

Correspondence Address: Patent Documentation Center, Xerox Corporation, Xerox Square, 20th Floor, 100 Clinton Ave. S., Rochester, NY, 14644, US

(73) Assignee: Xerox Corporation

(21) Appl. No.: 10/299,534

(22) Filed: Nov. 18, 2002

(51) Int. Cl. G06K 9/00

(52) U.S. Cl. 382/164

(57) ABSTRACT

An adaptive image segmentation system and methodology based on Mixed Raster Content (MRC) format. A L*a*b* color image is processed into an object-based MRC representation. By using L*a*b* data, an expectation-maximization algorithm is used to estimate a mixture of two 3-D Gaussians, with one Gaussian representing the background pixels and the other the foreground pixels. A resultant-quadratic decision surface is calculated and all image pixels are compared against it. Depending on which side of the decision surface any given pixel falls, that pixel goes to either the background or foreground plane. The pixel-by-pixel decisions are used to comprise a mask plane. The mask plane is converted into run lengths, which are “cleaned”, and regions are merged. Large connected components are reserved as windows and are used to mask out portions of the foreground. The result is a background plane, a mask plane, a foreground plane and any number of foreground/mask pairs, consistent with the ITU T.44 MRC specification. Using 3-D calculations in L*a*b* as opposed to just 1-D calculations in L*, and applying a quadratic surface provides a more robust solution to scanner choice and resolution. The methodology may also be combined with other processing steps such as compression, hints generation, and object classification.

### BACKGROUND

The present invention relates generally to image processing, and more particularly, to techniques for compressing the digital representation of a document.

Documents scanned at high resolutions require very large amounts of storage space. Instead of being stored as is, the data is typically subjected to some form of data compression in order to reduce its volume, and thereby avoid the high costs associated with storing and transmitting it. Although much content is online, there remains a substantial amount of information in paper documents. Workflows can require extracting information in printed forms, converting legacy documents, or committing content of paper documents to a storage and retrieval system. In document processing systems, scanning completes the cycle: electronic, print, electronic. Conversion of printed documents to electronic format has been the subject of thousands of research articles and numerous books. Most work has focused on binary black and white documents. Yet the majority of documents today are in color at increasingly higher resolutions.

One approach to satisfy the compression needs of differing types of data has been to use a Mixed Raster Content (MRC) format to describe the image. The image—a composite image having text intermingled with color or gray scale information—is segmented into two or more planes, generally referred to as the upper and lower plane, and a selector plane is generated to indicate, for each pixel, which of the image planes contains the actual image data that should be used to reconstruct the final output image. Segmenting the planes in this manner can improve the compression of the image because the data can be arranged such that the planes are smoother and more compressible than the original image. Segmentation also allows different compression methods to be applied to the different planes, thereby allowing a compression technique that is most appropriate for the data residing thereon can be applied to each plane.

From a document interchange perspective, the Mixed Raster Content (MRC) imaging model enables exemplary representation of basic document structures. Its intent is to facilitate high compression by segmenting a document image into a number of regions according to compression type. For example, text pixels are extracted and encoded with ITU-T G4 or JBIG2. Background and pictures are extracted and compressed with JPEG (perhaps at differing quantization levels). Thus a document image is partitioned into a number of regions according to appropriate compression schemes. But MRC can also describe a basic “functional” decomposition of the image: text, background, photographs, and graphics, which can be used for subsequent processing. For example, text can be “OCRed” (Optical Character Recognition) or photographs color corrected for different display media.

Central to the optimization of MRC is the segmentation of the document. The segmentation needs to be robust and adaptive to a multitude of scanners while minimizing “show through” from the backside of the scanned sheet. It also must be simple and fast, making it amenable to software execution. Finally, it should reduce much of the document analysis problem to processing binary images.

In U.S. Pat. No. 6,400,844, to Fan et al., the invention described discloses an improved technique for compressing a color or gray scale pixel map representing a document using an MRC format includes a method of segmenting an original pixel map into two planes, and then compressing the data or each plane in an efficient manner. The image is segmented by separating the image into two portions at the edges. One plane contains image data for the dark sides of the edges, while image data for the bright sides of the edges and the smooth portions of the image are placed on the other plane. This results in improved image compression ratios and enhanced image quality.

The above is herein incorporated by reference in its entirety for its teaching.

Therefore, as discussed above, there exists a need for a methodology to minimize the impact of segmentation on the operation of MRC or other scan systems, yet remain robust and adaptive to a multitude of scanners, while reducing much of the document analysis problem to that of processing binary images. Thus, it would be desirable to solve this and other deficiencies and disadvantages with an improved methodology for color document image segmentation.

The present invention relates to a method for creating a decision surface in 3D color space by determining a parametric model of foreground and background pixel distributions; estimating parametric model parameters from the foreground and background pixel distributions; and computing a decision surface from the parametric model parameters.

In particular, the present invention relates to a method for segmenting image data pixels in 3D color space comprising sampling a subset of the pixels in the image data, determining a parametric model of foreground and background pixel distributions from the subset of pixels, and estimating parametric model parameters from the foreground and background pixel distributions. This allows computing a decision surface from the parametric model parameters so as to compare all image data pixels against the decision surface, and determine as per the comparing step if a given data pixel is above or below the decision surface.

The present invention also relates to a method for adaptive color document segmentation comprising reading a raster image into memory, converting the raster image into L*a*b* color space, and sampling a subset of pixels at uniformly distributed points in the image. This allows determining a parametric model of foreground and background pixel distributions from the subset of pixels, estimating parametric model parameters from the resultant foreground and background pixel distributions, and computing a decision surface from the parametric model parameters. That in turn allows comparing all image pixels against the decision surface, determining as per the comparing step if a given image pixel is above or below the decision surface, and sorting the given image pixel into a foreground mask or a background mask as dependent upon the determination of being below or above the decision surface. Then a single bit in a selector mask is set for each pixel location as per the determination made in the determination step.

### BRIEF DESCRIPTION OF THE DRAWINGS

FIG. 1 illustrates a composite image and includes an example of how such an image may be decomposed into three MRC image planes—an upper plane, a lower plane, and a selector plane.

FIG. 2 contains a detailed view of a pixel map and the manner in which pixels are grouped to form blocks.

FIG. 3A shows two 3D distributions and decision surface in L*a*b* color space.

FIG. 3B shows a 2D slice through the distributions and decision surface of FIG. 3A.

FIG. 4 provides a flow chart for recursive document image segmentation.

### DESCRIPTION

The present invention is directed to a method for segmenting the various types of image data contained in a composite color document image. While the invention will described in a Mixed Raster Content (MRC) technique, it may be adapted for use with other methods and apparatus' and is not therefore, limited to a MRC format. The technique described herein is suitable for use in various devices required for storing or transmitting documents such as facsimile devices, image storage devices and the like, and processing of both color and grayscale black and white images are possible.

A pixel map is one in which each discrete location on the page contains a picture element or “pixel” that emits a light signal with a value that indicates the color or, in the case of gray scale documents, how light or dark the image is at that location. As those skilled in the art will appreciate, most pixel maps have values that are taken from a set of discrete, non-negative integers.

For example, in a pixel map for a color document, individual separations are often represented as digital values, often in the range 0 to 255, where 0 represents no colorant and 255 represents maximum colorant. For example, in the RGB color space, (0,0,0) represents an additive mixture of no red, no green, and no blue, hence (0,0,0) represents black; (0, 255, 0) represents no red, maximum green, and no blue, hence (0, 255, 0) represents green; (128, 128, 128) and additive mixture of equal amounts of a medium amount of reg, green, and blue, hence (128, 128, 128) represents a medium gray. Many other color spaces are used in the art to represent colors including L*a*b*, L*u*v*, and YCbCr. Each has its particular advantage is a particular imaging system (e.g., copiers, printers, CRTs, television transmission). Transformation from one color space to another is routine in the art and is performed using mathematical operations embodied in computer hardware or software. The three values of each separation represents coordinates of points in 3D space. The pixel maps of concern in a preferred embodiment of the present invention are representations of “scanned” images. That is, images which are created by digitizing light reflected off of physical media using a digital scanner. The term bitmap is used to mean a binary pixel map in which pixels can take one of two values, 1 or 0.

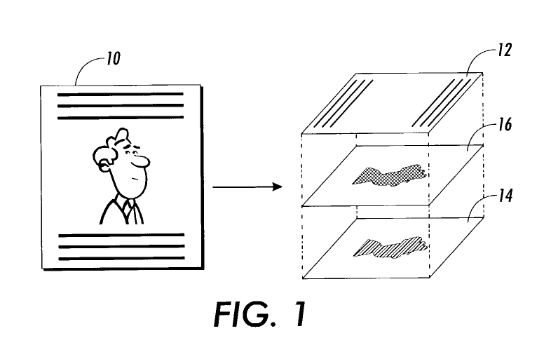

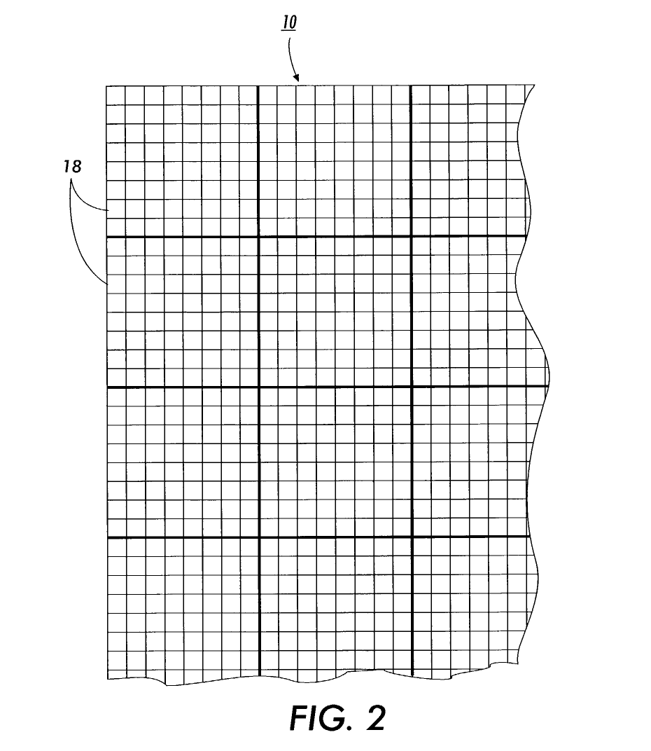

Turning now to the drawings for a more detailed description of the MRC format, pixel map 10 representing a color or gray-scale document is preferably decomposed into a three plane page format as indicated in FIG. 1. Pixels on pixel map 10 are preferably grouped in blocks 18 (best viewed in FIG. 2) to allow for better image processing efficiency. The document format is typically comprised of an upper plane 12, a lower plane 14, and a selector plane 16. Upper plane 12 and lower plane 14 contain pixels that describe the original image data, wherein pixels in each block 18 have been separated based upon pre-defined criteria. For example, pixels that have values above a certain threshold are placed on one plane, while those with values that are equal to or below the threshold are placed on the other plane. Selector plane 16 keeps track of every pixel in original pixel map 10 and maps all pixels to an exact spot on either upper plane 12 or lower plane 14.

The upper and lower planes are stored at the same bit depth and number of colors as the original pixel map 10, but possibly at reduced resolution. Selector plane 16 is created and stored as a bitmap. It is important to recognize that while the terms “upper” and “lower” are used to describe the planes on which data resides, it is not intended to limit the invention to any particular arrangement or configuration.

After processing, all three planes are compressed using a method suitable for the type of data residing thereon. For example, upper plane 12 and lower plane 14 may be compressed and stored using a lossy compression technique such as JPEG, while selector plane 16 is compressed and stored using a lossless compression format such as gzip or CCITT-G4. It would be apparent to one of skill in the art to compress and store the planes using other formats that are suitable for the intended use of the output document. For example, in the Color Facsimile arena, group 4 (MMR) would preferably be used for selector plane 16, since the particular compression format used must be one of the approved formats (MMR, MR, MH, JPEG, JBIG, etc.) for facsimile data transmission.

In the present invention digital image data is preferably processed using a MRC technique such as described above. Pixel map 10 represents a scanned image composed of light intensity signals dispersed throughout the separation at discrete locations. Again, a light signal is emitted from each of these discrete locations, referred to as “picture elements,” “pixels” or “pels,” at an intensity level which indicates the magnitude of the light being reflected from the original image at the corresponding location in that separation.

Central to the present invention is a segmentation system utilizing an expectation-maximization algorithm to fit a mixture of three-dimensional gaussians to L*a*b* pixel samples. From the estimated densities and proportionality parameter, a quadratic decision boundary is calculated and applied to every pixel in the image. A binary selector plane is maintained that assigns one to the selector pixel value if the pixel is foreground and zero otherwise (background). The component distribution with the greater luminance is assigned the role of a background prototype. This process is essentially 3D thresholding. If the Euclidean distance of the estimated means are close together, or if the estimated proportionality parameter is near zero or one, the samples fail to exhibit a clear mixture —the sample is homogenous or is not well-fitted with a mixture of 3D gaussians. At this stage, a segmentation attempt is made using only the L* channel by a mixture of 1D gaussians. Again, if estimated means are close or the estimated proportionality parameter is close to zero or one, the segmenter reports that the document image cannot be segmented.

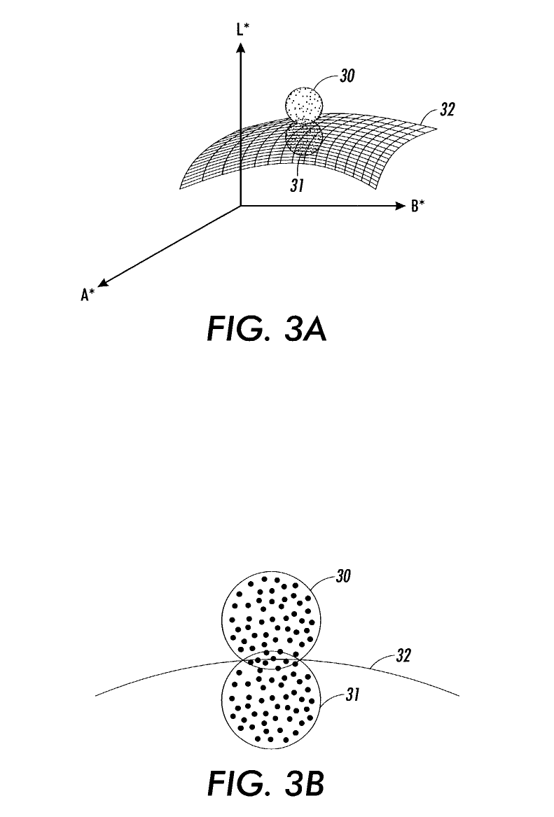

FIG. 3A is a simplified depiction of the above description provided as an aid in the visualization of the methodology employed. FIG. 3A is an example of when the samples exhibit a well fitted mixture of 3D gaussians 30 and 31. Gaussian 30 represents background (lighter) pixel samples and gaussian 31 is the foreground (darker) pixel samples. By calculating the quadratic decision boundary a resultant (inverted cup shaped) binary selector plane 32 is maintained which allows expeditious thresholding of the remainder of the document page. FIG. 3B is a 2D slice of FIG. 3A to aid in further visually clarifying the relationship of sample pixel gaussians 30 and 31 and resultant binary selector 32.

Next, the selector is processed to find connected components by first doing a morphological opening and then a closing. Large connected components are extracted as objects and output as foreground/mask pairs. The segmented document image is now ready for subsequent processing. The objects may be smoothed or enhanced according to image type, the selector plane subjected to further analysis as a binary document image, etc. Also, one may compress the image according to the TIFF-FX profile M standard or variant.

Expectation-Maximization (EM) is a general technique for maximum-likelihood estimation (mles) when data are missing. The seminal paper is A. P. Dempster, N. M. Laird, and D. B. Rubin, Maximum likelihood from incomplete data via the EM algorithm (with discussion), Journal of the Royal Statistical Society B, 39, pp. 1-38 (1977). and a recent comprehensive treatment is G. J. McLachlan and T. Krishnan, The EM Alqorithm and Extensions, Wiley, New York (1997) both of which are herein incorporated by reference for their teaching. The mixture-of-gaussians (MoG) estimation problem is a straightforward and intuitive application of EM.

There are other approaches to this problem. Estimating the MoG can be thought of as unsupervised pattern recognition.

Consider two multivariate normal distributions

$${f}_{ i} ( x ; {μ}_{i} , {Σ}_{i} ) , i = 1 , 2.$$

The MoG distribution is

$$f ( x ; {μ}_{1} , {μ}_{2} , {Σ}_{1} , {Σ}_{2} ) = α f ( x ; {μ}_{1} , {Σ}_{1} ) + ( 1 - α ) f ( x ; {μ}_{2} , {Σ}_{2} )$$

where 0≦α≦1 is the proportionality parameter. Given an i.i.d sample x={xᵢ; i=1, . . . , N} from f, one would like to compute maximum likelihood estimates of the proportion, the vector means and covariance matrices. Unfortunately, no closed form is known (unlike the homogeneous case). One must maximize the likelihood numerically,

$$L ( x ; α , {μ}_{1} , {Σ}_{1} , {μ}_{2} , {Σ}_{2} ) = {\prod }_{i = 1}^{N} [ α f ( x ; {μ}_{1} , {Σ}_{1} ) + ( 1 - α ) f ( {x}_{i} ; {μ}_{2} , {Σ}_{2} ) ] \qquad ( 1 )$$

The EM algorithm provides an iterative and intuitive method to produce mles.

The missing data in this case is membership information. Let Zᵢⱼ=1 if Xⱼ is from f(•; μᵢ, Σᵢ), and zero otherwise, i=1, 2 The unobserved random variable Zᵢⱼ indicates to which distribution the observation belongs: P(Z₁ⱼ=1)=α. Were, in fact, Zᵢⱼ observed, we could form mles. Let Zᵢⱼ=zᵢⱼ and form the likelihood

$$L ( x ; α , {μ}_{1} , {Σ}_{1} , {μ}_{2} , {Σ}_{2} ) = {\prod }_{j = 1}^{N} {[ α f ( {x}_{j} ; {μ}_{1} , {Σ}_{1} ) ]}^{{z}_{1 j}} \times {[ ( 1 - α ) f ( {x}_{j} ; {μ}_{2} , {Σ}_{2} ) ]}^{{z}_{2 j}} \qquad ( 2 )$$

which yields mles

$$\begin{matrix}\hat{α} = \frac{1}{N} {\sum }_{j = 1}^{N} {z}_{1 j} & ( 3 ) \\ {\hat{μ}}_{i} = \frac{1}{N} {\sum }_{j = 1}^{N} {x}_{i j} / {\sum }_{j = 1}^{N} {z}_{i j} , i = 1 , 2 & ( 4 )\end{matrix}$$

and covariance mles omitted for brevity.

If we new the parameter values, we could estimate zᵢⱼ by conditional expectations

$$\begin{matrix} {\hat{z}}_{i j} = E ( {Z}_{i j} \vert α , {μ}_{1} , {Σ}_{1} , {μ}_{2} , {Σ}_{2} ) \\ = \frac{f ( {x}_{j} ; {μ}_{1} , {Σ}_{1} )}{α f ( {x}_{j} ; {μ}_{1} , {Σ}_{1} ) + ( 1 - α ) f ( {x}_{j} ; {μ}_{2} , {Σ}_{2} )}\end{matrix} \qquad ( 5 )$$

The first step in the EM algorithm is to initialize parameter estimates, \hat{α}^{(0), \hat{μ}}₁⁽⁰⁾, \hat{Σ}₁⁽⁰⁾, \hat{μ}₂⁽⁰⁾, \hat{Σ}₂⁽⁰⁾. The next step, the “E-step,” is to use equation (5) to get estimates of the zᵢⱼ. The next step, the “M-step” is to use these estimates of the zᵢⱼ and the original data in equations (3) and (4) to get updated mles of the parameters. The algorithm iterates these two steps until some measure of convergence is achieved (typically, updated parameter estimates differ little from previous ones, or the likelihood value stabilizes). That's essentially all there is to it for mixture-of-gaussians (MoG). The fact that such a simple and intuitive method works under general conditions is makes it an important tool in late 20th century statistics.

Document image segmentation may be done for a number of reasons. Recently, there has been interest in segmenting a document image for compression. In this case, segmentation classes are compression classes, i.e., regions amenable to compression with appropriate algorithms: text with ITU-T Group 4 (MMR) and color images with JPEG. One advantage of this approach is that one avoids compressing text with JPEG where it is known to produce ringing and mosquito noise. One can also use segmentation to find rendering classes, e.g., halftone regions to be descreened, text to be sharpened, and photos to be enhanced.

Mixed raster content is an imaging model directed toward facilitating compression, yet it can be used as a “carrier” for documents segmented for rendering or layout analysis.

Formally, we represent a color image as a mapping from a raster to a triplet of 8-bit colors:

I:[mₓ,n_{y}]×[m_{y},nₓ]→[0,255]³

where 0≦mₓ<nₓ and 0≦m_{y}<n_{y}. A 3-plane mixed raster content representation uses a mask M to separate background and foreground content. Let mₓ=m_{y}=0 and

M0:[0,nₓ]×[0,n_{y}]→{0,1}

be a binary mask where nₓ and n_{y} represent the complete extent of the image raster. Let

FG0, BG0: [0, nₓ]×[0, n_{y}], →[0, 255]³

be foreground and background images, respectively. A 3-plane MRC document image representation is

I(x,y)=(1−M0(x, y))BG0(x, y)+M0(x, y)FG0(x, y)

for (x, y)∈[0, nₓ]×[0,n_{y}].

Essentially, a (vector) pixel value is selected from the background, if the mask is zero, and from the foreground if the mask is one. One can view the imaging operation as pouring the foreground through a mask onto the background.

We also need the concept of an object, which is a foreground/mask pair meant to represent a photograph or graphic. An object foreground is an image FGi and a mask Mi:

FGi:[miₓ,niₓ]×[mi_{y},ni_{y}]→[0,255]³

Mi:[miₓ, niₓ]×[mi_{y},ni_{y}]→{0, 1}

where 0≦miₓ<niₓ≦nₓ and 0≦mi_{y}<ni_{y}≦n_{y}.

An object is imaged by Oᵢ(x, y)=Mi(x, y)FGi(x, y) for (x, y)∈[miₓ, niₓ]×[mi_{y}, ni_{y}] and zero elsewhere. The number of objects that can appear on a page is not a priori restricted except that objects cannot overlap (for we cannot segment them if they do), and they must have a certain minimum area (say, 2 square inches). The final document raster is imaged as

$$I ( x , y ) = ( 1 - M0 ( x , y ) ) B G0 ( x , y ) + M0 ( x , y ) F G0 ( x , y ) + {\sum }_{i = 1}^{N} {O}_{i} ( x , y )$$

This decomposition is by no means unique and there are others more appropriate for compression.

A exemplary segmentation methodology comprises:

1) Read a raster image into memory

2) Convert it to L*a*b*

3) Sample the image at a number of uniformly distributed points

4) Using the Expectation-Maximization (EM) algorithm to estimate a mixture parameter, two 3D means and the covariance matrices: \hat{α}, \hat{μ}_{f}, \hat{Σ}_{f}, \hat{μ}_{b}, \hat{Σ}_{b} presumably representing foreground and background gaussians; i.e., the data are fit with αf(x;μ_{b},Σ_{b})+(1−α)f(x;μ_{b},Σ_{b}), where x=(l*,a*,b*) at a point. This is done to yield a quadratic decision surface 32.

5) Compare each image pixel to the decision surface 32 and thereby separate each pixel into a foreground or background plane, while also capturing that steering decision into a selector mask plane. If ∥\hat{μ}_{b}(l*)−\hat{μ}_{f}(l*)∥<t and s₁≦\hat{α}≦s₂ then foreground and background are well-separated in L*a*b*

a. For each pixel x in the image, if \hat{α}f(x; \hat{μ}_{b}, \hat{Σ}_{b})<(1−\hat{α})f(x; \hat{μ}_{b}, \hat{Σ}_{b} x in the background and put a “0” in the mask M0 at that point; else put X in the foreground and put a “1” in the mask M0 at that point.

b. Make a copy S of the mask M0.

c. Convert S to horizontal run-lengths and do a closing with a horizontal element (this closes small gaps)

d. Convert S to vertical run-lengths and do a closing with a vertical element (this closes small gaps)

e. Convert S to horizontal run-lengths and do an opening with a horizontal element (this smoothes window boundaries)

f. Convert S to vertical run-lengths and do an opening with a vertical element (this smoothes window boundaries)

g. Convert S to connected components.

h. For each connected component Mi larger than a variable “thresh” in area

i. Remove Mi from M0

ii. Mask out Mi from FG0 making FG0 white where Mi is “1” and copying those pixels to a new object foreground FGi

iii. Fill the holes in Mi by

1. Finding small connected components in Mi of “0”-valued pixels

2. Painting those connected components “1”.

iv. Output the found object as a foreground/mask pair (FGi,Mi)

i. Output the background BG0, the mask (selector) M0, and foreground FG0

6) If ∥\hat{μ}_{b}(l*)−\hat{μ}_{f}(l*)∥≦t and s₁≦\hat{α}≦s₂ then fit a 1D mixture of gaussians to the L* values and perform step 5 (which can be reduced to a simple threshold operation).

7) Else the data form one gaussian blob or the EM algorithm failed to return a reasonable estimate, return the original image as BG0.

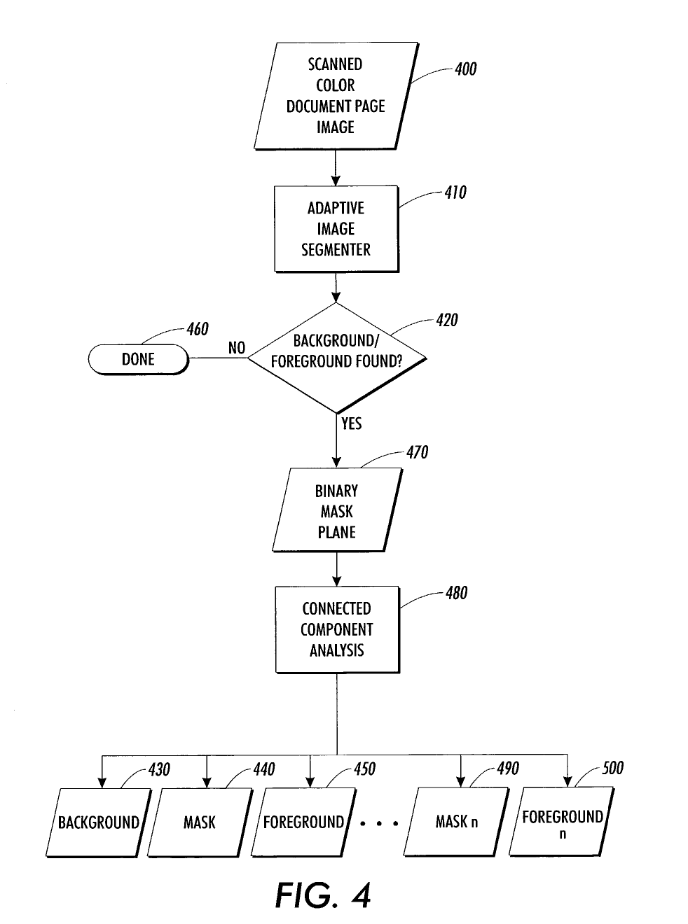

Turning now to FIG. 4 there is depicted a flow chart for employing the segmentation methodology described above into a Mixed Raster Content embodiment. As shown with start block 400, initially a document page is scanned. A raster image is read in and converted to yield a L*a*b* image. At block 410 the adaptive image segmenter is employed as previously described above. To recapitulate the segmenter methodology: a uniform sampling of pixels across the image is taken; the number of samples may vary but in one preferred embodiment 2000 samples are employed; Expectation-Maximization is applied to the sample pixel data to yield an estimate of parametric model parameters comprising a mixture parameter, two 3D means and corresponding covariance matrices; a quadratic decision surface is computed from the parametric model parameters; this quadratic decision surface is employed as a binary selector plane and each document image data pixel is then compared against the decision surface to determine each pixel as designated either background or foreground; if as a result of that comparison a foreground and background are indeed found at decision block 420, the pixel by pixel designation determination from the comparison is used to create a binary mask plane block 470, else the methodology is complete as indicated with end-block 460.

In block 480 the binary mask plane is converted into run lengths, cleaned using morphological open and close operations, and regions larger than a given threshold are merged. Large connected components are reserved as windows and are used to mask out portions of the preliminary foreground 450. The reserved large connected components are subtracted out from the preliminary foreground and the mask plane. The initial result is a background plane 430, a mask plane 440, and a preliminary foreground plane 450. The reserved large connected components are reiteratively processed (as just described above) starting again at block 410 through to block 480, to yield any “n” number of foreground/mask pairs 490, 500, until no further pairs are found, as determined at decision block 420. The methodology is then complete as indicated with end-block 460.

It may be desirable or otherwise advantageous to replace all the pixel values in a background mask with an average value. This will help suppress show through artifacts, such as are typical when scanning duplex originals where backside images are visible from the front side.

In closing, by providing a methodology to minimize the impact of segmentation on the operation of MRC or other scan systems, there is provided an approach robust and adaptive to a multitude of scanners, which also reduces the document analysis problem to that of processing binary images. The above methodology may also be combined with other processing steps such as compression, hints generation, and object classification.

While the embodiments disclosed herein are preferred, it will be appreciated from this teaching that various alternative modifications, variations or improvements therein may be made by those skilled in the art. All such variants are intended to be encompassed by the following claims:

1. A method for creating a decision surface in 3D color space comprising:
determining a parametric model of foreground and background pixel distributions;
estimating parametric model parameters from the foreground and background pixel distributions; and,
computing a decision surface from the parametric model parameters.

2. The method of claim 1 wherein the parametric model is a mixture of two gaussian distributions.

3. The method of claim 2 wherein the determining step further comprises using an expectation-maximization algorithm.

4. The method of claim 3 wherein the determining step further comprises mixture-of-gaussians estimation.

5. The method of claim 2 wherein the parametric model parameters comprise a mixture parameter, two 3D means with two corresponding covariance matrices.

6. A method for segmenting image data pixels in 3D color space comprising:
sampling a subset of the pixels in the image data;
determining a parametric model of foreground and background pixel distributions from the subset of pixels;
estimating parametric model parameters from the foreground and background pixel distributions;
computing a decision surface from the parametric model parameters;
comparing all image data pixels against the decision surface; and,
determining as per the comparing step if a given data pixel is above or below the decision surface.

7. The method of claim 6 wherein the parametric model is a mixture of two gaussian distributions.

8. The method of claim 7 wherein the determining step further comprises using an expectation-maximization algorithm.

9. The method of claim 8 wherein the determining step further comprises mixture-of-gaussians estimation.

10. The method of claim 9 wherein the parametric model parameters comprise a mixture parameter, two 3D means with two corresponding covariance matrices.

11. The method of claim 8 further comprising: sorting the given data pixel into a foreground or a background mask as dependent upon the determination of being below or above the decision surface.

12. A method for adaptive color document segmentation comprising:
reading a raster image into memory;
converting the raster image into L*a*b* color space;
sampling a subset of pixels at uniformly distributed points in the image;
determining a parametric model of foreground and background pixel distributions from the subset of pixels;
estimating parametric model parameters from the resultant foreground and background pixel distributions;
computing a decision surface from the parametric model parameters;
comparing all image pixels against the decision surface;
determining as per the comparing step if a given image pixel is above or below the decision surface;
sorting the given image pixel into a foreground mask or a background mask as dependent upon the determination of being below or above the decision surface and, setting a single bit in a selector mask for each pixel location as per the determination made in the determination step.

13. The method of claim 12 wherein the reading step is performed in a scanner.

14. The method of claim 12 wherein the converting step is performed in a scanner.

15. The method of claim 12 wherein the parametric model is a mixture of two gaussian distributions.

16. The method of claim 15 wherein the determining step further comprises using an expectation-maximization algorithm.

17. The method of claim 16 wherein the determining step further comprises mixture-of-gaussians estimation.

18. The method of claim 12 wherein the parametric model parameters comprise a mixture parameter, two 3D means with two corresponding covariance matrices.

19. The method of claim 12 further comprising replacing all the pixel values in the background mask with an average value.
